(19) United States
(12) Patent Application Publication
(10) Pub. No.: US 2018/0195315 A1
(43) Pub. Date: Jul. 12, 2018

(54) FREEWHEELING INERTIA MECHANISM FOR CLOSURE LATCH ASSEMBLY

(71) Applicant: Magna Closures Inc., Newmarket (CA)

(72) Inventor: Ann-Margaret MOZOLA, Lakefield (CA)

(21) Appl. No.: 15/862,843

(22) Filed: Jan. 5, 2018

Related U.S. Application Data
(60) Provisional application No. 62/443,026, filed on Jan. 6, 2017.
(60) Provisional application No. 62/540,853, filed on Aug. 3, 2017.

(51) Int. Cl. E05B 77/06; E05B 77/32; E05B 85/10

(52) U.S. Cl. CPC E05B 77/06; E05B 85/10; E05B 77/32

(57) ABSTRACT

A closure latch assembly for automotive closure systems includes a latch mechanism, a latch release mechanism, a handle-actuated release mechanism, and an inertia-activated bypass mechanism disposed between the handle-actuated release mechanism and the latch release mechanism. The inertia-activated bypass mechanism is operable in a coupled mode for drivingly connecting the two mechanisms so as to permit the latch release mechanism to actuate the latch mechanism and is further operable in an uncoupled mode for disconnecting the two mechanisms so as to inhibit operation of the latch release mechanism. An inertia force above a predetermined acceleration threshold applied to a coupling component of the bypass mechanism causes shifting from the coupled mode into the uncoupled mode, thereby inhibiting unintended release of the latch mechanism.

### CROSS-REFERENCE TO RELATED APPLICATIONS

This application claims the benefit of U.S. Provisional Application Ser. No. 62/540,853, filed Aug. 3, 2017, and the benefit of U.S. Provisional Application Ser. No. 62/443,026, filed Jan. 6, 2017, both of which are incorporated herein by reference in their entirety.

### FIELD

The present disclosure relates generally to closure latch assemblies of the type used in motor vehicle closure systems. More particularly, the latch assembly of the present disclosure is equipped with a latch release mechanism having an integrated inertia bypass device.

### BACKGROUND

This section provides background information related to motor vehicle closure systems and is not necessarily prior art to the closure latch assembly of the present disclosure.

A vehicle closure panel, such as a door for a vehicle passenger compartment, is hinged to swing between open and closed positions and includes a closure latch assembly mounted within the door. The closure latch assembly functions in a well-known manner to latch the door when it is closed and lock the door in its closed position, and to unlatch the door to permit subsequent movement of the door to its open position. As is also well known, the closure latch assembly is configured to include a latch mechanism for latching the door, a lock mechanism interacting with the latch mechanism for locking the door, and a latch release mechanism interacting with the lock mechanism and the latch mechanism for unlocking/unlatching the door. These mechanisms can be manually operated and/or power-operated to provide the desired level of standard features.

During a vehicle crash or other emergency situation, the vehicle doors must be kept closed independently of unintended handle activations or other user or external interventions (i.e. deformation of the door handles and/or latch release components that can cause the latch mechanism of the closure latch assembly to prematurely unlatch during the crash event). Thus, it is also known to configure closure latch assemblies to inhibit the unintended opening of the door in the event of high inertial loading being applied thereto due to rapid acceleration/deceleration of the vehicle and/or due to a vehicular collision. In many instances, the closure latch assembly is equipped with some type of additional “safety” mechanism or device to provide this feature. Some such safety devices employ an inertial member that swings into a blocking position relative to a moveable component of the latch release mechanism or the latch mechanism, as a result of predefined accelerations occurring during a crash event for example, to inhibit unintended release of the latch mechanism. Other safety devices for door latch assemblies employ a control system configured to detect a high acceleration event and actuate a power-operated device to drive a blocking member into the blocking position. As an option to integrating the safety device into the closure latch assembly, it is also known to incorporate an inertia locking device into the release cable interconnecting a door handle to the latch release mechanism. In such “blocking” type of inertial safety devices, the blocking component must be configured to withstand collision forces as well as permit release of the blocking function to permit subsequent opening of the door.

In view of the above, a need exists to develop alternative inertia-type safety devices for motor vehicle closure latch assemblies that provide enhanced operation without increasing latch complexity, cost and packaging requirements.

### SUMMARY

This section provides a general summary and is not intended to be an exhaustive and comprehensive listing of all possible aspects, features and objectives associated with the present disclosure.

It is an objective of the present disclosure to provide a vehicle closure system having an inertia-activated safety arrangement configured to obviate or mitigate at least some of the shortcomings associated with the above-noted “blocking” type safety systems.

It is an aspect of the present disclosure to provide a closure latch assembly equipped with a latch mechanism, a latch release mechanism, a handle-actuated release mechanism, and an inertia-activated bypass mechanism operably disposed between the latch release mechanism and the handle-actuated release mechanism. The inertia-activated bypass mechanism includes a free-wheeling inertia device operable in a coupled mode to operably connect the handle-actuated release mechanism to the latch release mechanism and in an uncoupled mode to operably disconnect the handle-actuated release mechanism from the latch release mechanism. With the bypass mechanism operating in the coupled mode, application of a relatively low inertial load to the inertia device permits activation of the latch release mechanism for releasing the latch mechanism via intentional actuation of the handle-actuated release mechanism. In contrast, application of a high inertial load to the inertia device automatically shifts the bypass mechanism into the uncoupled mode so as to prevent release of the latch mechanism via unintentional actuation of the handle-actuated release mechanism. It is to be understood that the low inertial load is typical of normal, intended manual operation of the handle-actuated release mechanism required to open a vehicle door. On the contrary, it is to be understood that the high inertial load is associated with non-typical, unintended actions such as loads generated in response to a collision incident or a high acceleration event.

The inertia-activated bypass mechanism of the present disclosure is configured to move a coupling component between a coupled position for establishing the coupled mode and an uncoupled position for establishing the uncoupled mode. The coupling component is normally biased toward its coupled position. An inertial force exerted on the coupling component at a speed and/or acceleration exceeding a predetermined threshold value, such as generated in response to a collision incident or a high acceleration event, functions to move the coupling component from its coupled position to its uncoupled position. The coupling component is operable in its coupled position to permit intended actuation of the latch release mechanism, thereby allowing the latch mechanism to be intentionally unlatched, and is further operable in its uncoupled position to bypass the latch release mechanism, thereby causing the latch mechanism to remain latched. The coupling component automatically returns to its coupled position for automatically resetting the bypass mechanism.

In accordance with this aspect, the present disclosure is directed to a closure latch assembly equipped with a latch release mechanism, a handle-actuated release mechanism, and an inertia-activated bypass mechanism. The inertia-activated bypass mechanism is operably disposed between an outside release lever associated with the handle-actuated release mechanism and a latch release lever associated with the latch release mechanism and includes an “unbalanced” link lever having an inertial mass fixed thereto. The unbalanced link lever is pivotably mounted on the outside release lever and is configured to selectively engage the latch release lever. A link lever spring is disposed between the link lever and the outside release lever and provides a resisting force configured to counter an inertial force present at the link lever's inertial mass. During normal (low acceleration) actuation of the outside release lever (via intended activation of an outside door handle), the link lever is located in a “coupled” position relative to the latch release lever such that the link lever mechanically engages (i.e. establishes a coupled mode) the latch release lever and functions to forcibly move the latch release lever from its rest position to its fully actuated position for releasing the latch mechanism, whereby the closure latch assembly is unlatched. In contrast, during a high acceleration event, the inertial force of the unbalanced link lever overcomes the resisting force exerted by the link lever spring and causes the link lever to pivot on the outside release lever to an “uncoupled” position relative to the latch release lever such that the link lever is mechanically disengaged (i.e. establishes an uncoupled mode) from the latch release lever for maintaining the latch release lever in its rest position, whereby the closure latch assembly remains latched.

In accordance with the present disclosure, a non-blocking type of inertia-activated safety device is provided by the inertia-activated bypass mechanism which is operably associated with the latch release mechanism and which is operable to shift from its normal operating coupled mode into its uncoupled mode when a high acceleration event occurs so as to desirably maintain the closure latch assembly in its latched state. The safety device is configured to automatically return to its normal coupled mode following the high acceleration event, thereby allowing the latch mechanism to be unlatched via normal, intended activation of an inside and/or outside door handle.

In accordance with a further aspect of the present disclosure, the link lever can pivot along a first arc of travel when the acceleration is below the predetermined acceleration threshold and can pivot along a second arc of travel when the acceleration is above the predetermined acceleration threshold, wherein the first arc of travel is different from the second arc of travel.

In accordance with a further aspect of the present disclosure, to facilitate desired movement of the link lever between the coupled and uncoupled modes, the inertial mass is offset relative to a resultant force vector acting on the link lever from the acceleration applied to the translational component.

In accordance with a further aspect of the present disclosure, the latch member can be provided having a forked drive notch configured for receipt of a drive lug on the latch release lever when the link lever is in its coupled position.

In accordance with a further aspect of the present disclosure the latch member can be provided with a shoulder configured to push on a drive lug on the latch release lever when the link lever is in its coupled position.

In accordance with a further aspect of the present disclosure, the latch member can be provided being hook-shaped to pull on a drive lug on the latch release lever when the link lever is in its coupled position.

In accordance with a further aspect of the present disclosure, the path traveled by the inertial mass and the link lever between the coupled position and the uncoupled position is not constrained by a predetermined path, thereby allowing enhanced and efficient movement of the link lever in unconstrained fashion.

Further areas of applicability will become apparent from the detailed description provided herein. As noted, the description provided in this summary section are intended for purposes of illustration only and is not intended to limit the scope of the present disclosure.

### DRAWINGS

The foregoing and other aspects will now be described by way of non-limiting examples with reference to the attached drawings in which:

FIG. 1 is a partial perspective view of a motor vehicle equipped with a door having a closure latch assembly constructed in accordance with and embodying the teachings of the present disclosure;

FIG. 2 is a plan view of a latch mechanism associated with the closure latch assembly of the present disclosure;

FIGS. 3A-3C are plan views of the latch mechanism shown in FIG. 2 respectively illustrating a primary latched state, a secondary latched state, and an unlatched state;

FIG. 4 is a plan view of an inertia-activated bypass mechanism operably disposed between a handle-actuated release mechanism and a latch release mechanism within the closure latch assembly and which is constructed in accordance with a first embodiment of the present disclosure;

FIGS. 5A-5C are plan views of the inertia-activated bypass mechanism shown in FIG. 4 operating in a first or “coupled” mode for operably coupling the handle-actuated release mechanism to the latch release mechanism and sequentially illustrating actuation of the latch release mechanism via the handle-actuated release mechanism in response to a normal, low acceleration input applied to a door handle;

FIGS. 6A and 6B are plan views of the inertia-activated bypass mechanism shown in FIG. 4 operating in a second or “uncoupled” mode for operably uncoupling the handle-actuated release mechanism from the latch release mechanism in response to a high acceleration input applied to the door handle;

FIGS. 7A and 7B are plan views of the inertia-activated bypass mechanism shown in FIG. 4 operating in a third or “bypass” mode when the closure latch assembly is operating in a locked mode;

FIGS. 8A-8C are plan views of another inertia-activated bypass mechanism operably disposed between a handle-actuated release mechanism and a latch release mechanism within the closure latch assembly and which is constructed in accordance with a second embodiment of the present disclosure with FIGS. 8A and 8B showing the inertia-activated bypass mechanism operating in a first or “coupled” mode and FIG. 8C showing the inertia-activated bypass mechanism operating in a second or “uncoupled” mode;

FIGS. 9A-9B are plan views of yet another inertia-activated bypass mechanism operably disposed between a handle-activated release mechanism and a latch release mechanism within the closure latch assembly and which is constructed in accordance with a third embodiment of the present disclosure with FIG. 9A showing the inertia-activated bypass mechanism operating in a first or “coupled” mode and FIG. 9B showing the inertia-activated bypass mechanism operating in a second or “uncoupled” mode; and

FIGS. 10A-10D are plan views of another inertia-activated bypass mechanism operably disposed between both the inside and outside handle-activated release mechanisms and a latch release mechanism within the closure latch assembly of the present disclosure.

Corresponding reference numerals are used throughout the several views of the drawings to indicate corresponding components, unless otherwise indicated.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

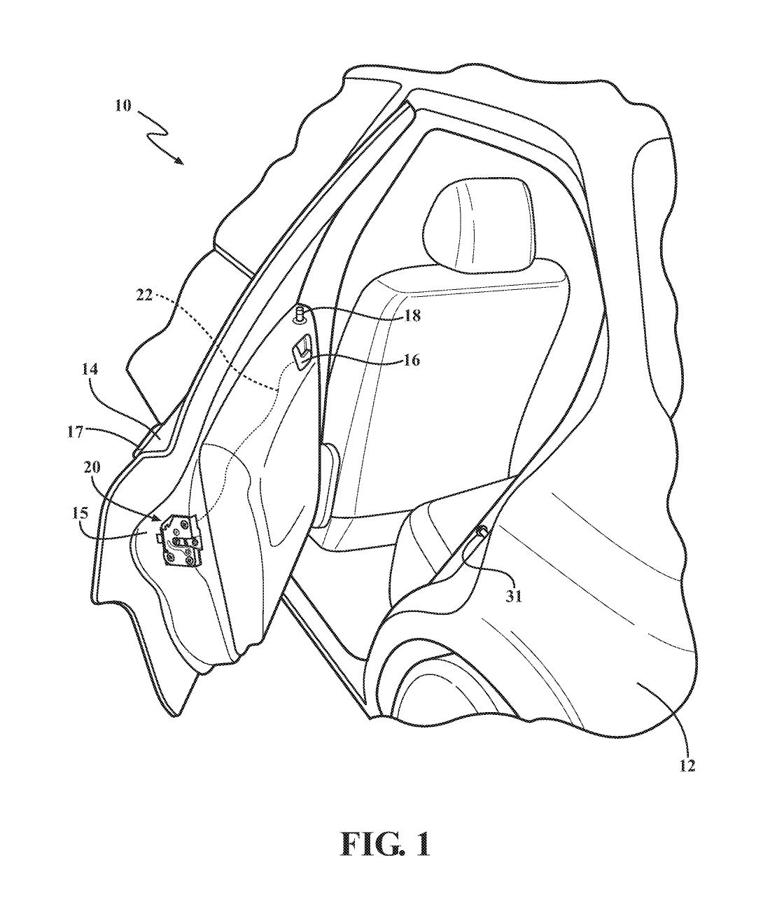

FIG. 1 is a partial isometric view of a motor vehicle 10 having a vehicle body 12 and at least one closure member, shown as vehicle passenger door 14, by way of example and without limitation. Vehicle door 14 is hinged to vehicle body 12 for movement between closed and open positions. Vehicle door 14 includes an inside door handle 16, an outside door handle 17, a lock knob 18, and a closure latch assembly 20 positioned on an edge face 15 of door 14. As will be detailed, closure latch assembly 20 includes a latch mechanism 40 configured to releasably latch a striker 31 fixed to vehicle body 12, a latch release mechanism 91 configured to selectively release the latch mechanism 40, a lock mechanism configured to selectively lock the latch mechanism 40, an inside handle-actuated release mechanism configured to connect inside door handle 16 to the latch release mechanism 91, and an outside handle-actuated release mechanism configured to connect outside door handle 17 to the latch release mechanism 91. However, it should be understood that the particular construction of these specific mechanisms is not critical or limiting to the present disclosure which relates to integration of an inertia-activated bypass mechanism between components of at least one of the handle-actuated release mechanisms and components of the latch release mechanism 91. As will be detailed hereafter, the inertia-activated bypass mechanism is configured to include an unbalanced inertia-weighted device operable to prevent unintended and unwanted unlatching of closure latch assembly 20, such as during an event causing a high acceleration of outside door handle 17 or components, including a release cable, of the outside handle-actuated release mechanism, such as during a crash event, by way of non-limiting example.

While the closure member is illustrated as a passenger door 14, it is to be understood that closure latch assembly 20 to be described can likewise be adapted for use with alternative closure members such as, and without limitation, liftgates, tailgates, hatch doors, sliding doors, trunk lids and engine compartment hoods.

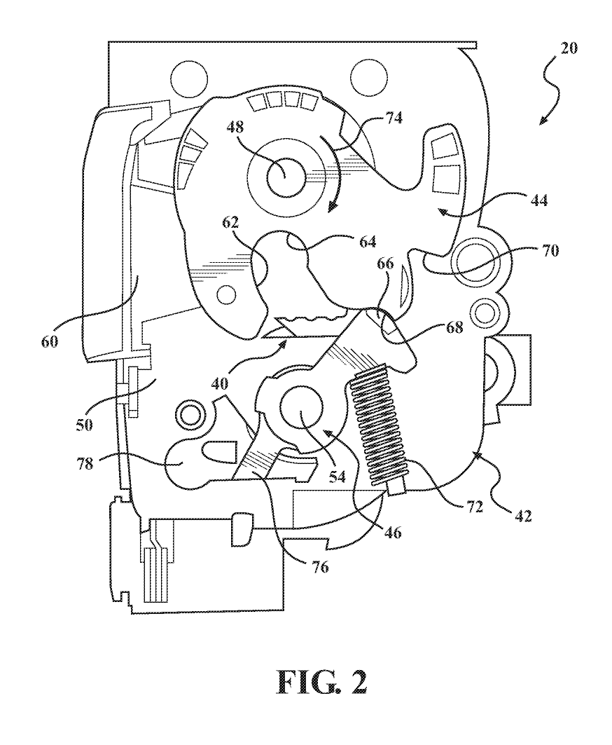

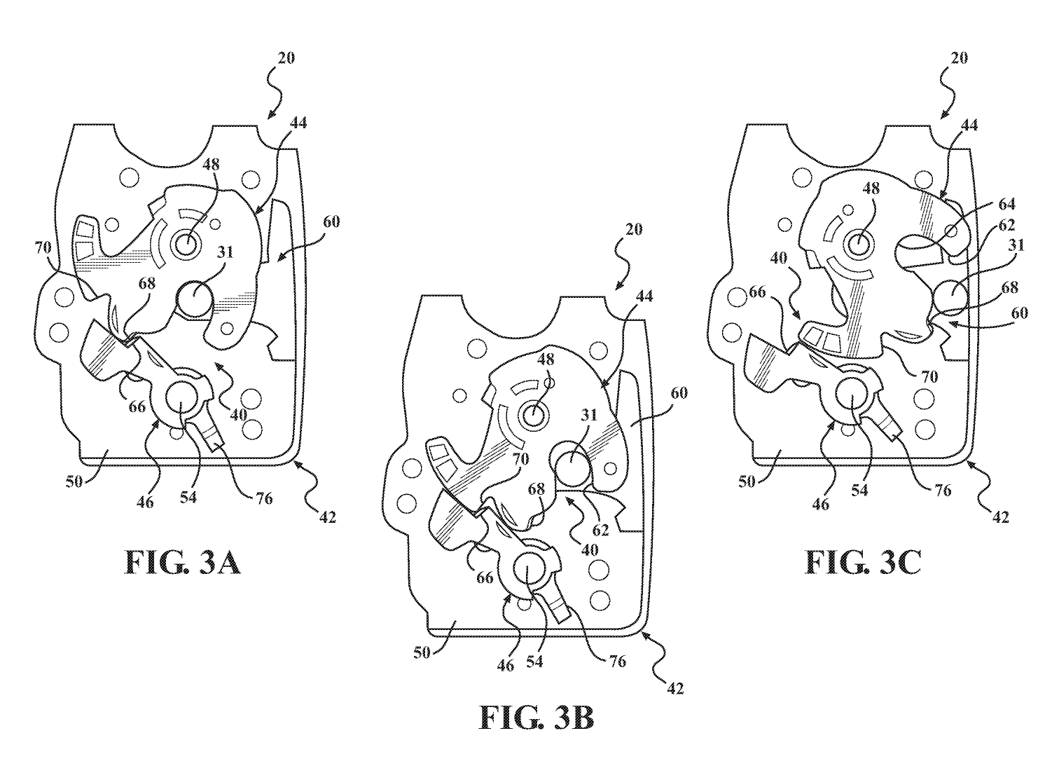

Referring initially to FIGS. 2 and 3, latch mechanism 40 of closure latch assembly 20 is shown located within a latch housing 42 and configured as a traditional ratchet-pawl arrangement having a ratchet 44 and a pawl 46. Ratchet 44 is pivotably mounted via a ratchet pivot post 48 to a plate section 50 of latch housing 42. Likewise, pawl 46 is pivotably mounted via a pawl pivot post 54 to plate section 50 of latch housing 42. A frusto-trapezoidal channel, commonly referred to as fishmouth 60, is formed in plate segment 50 of latch housing 42 and is configured to receive striker 31 upon movement of door 14 toward its closed position. Specifically, striker 31 is configured to engage a striker retention slot 62 and a striker capture notch 64 formed in ratchet 44.

Ratchet 44 is shown in FIG. 3A rotated by striker 31 to a primary striker capture position with pawl 46 located in a ratchet holding position such that a latch shoulder 66 formed on pawl 46 engages a primary latch notch 68 formed in ratchet 44, whereby striker 31 is held within striker capture notch 64. Ratchet 44 is shown in FIG. 3B rotated to a secondary striker capture position with pawl 46 again located in its ratchet holding position such that latch shoulder 66 on pawl 46 now engages a secondary latch notch 70 formed in ratchet 44, whereby striker 31 is located within retention slot 62. Finally, ratchet 44 is shown in FIG. 3C rotated to a striker release position and pawl 46 is shown located in a ratchet releasing position. Pawl 46 is normally biased toward its ratchet holding position via a pawl biasing member, shown by way of example and without limitation as a pawl spring 72, while ratchet 44 is normally biased toward its striker release position via a ratchet biasing member, shown by way of example and without limitation as a ratchet spring shown schematically by arrow 74. FIG. 3B illustrates closure latch assembly 20 operating in a primary latched mode with door 14 fully closed. FIG. 3A illustrates closure latch assembly 20 operating in a secondary latched mode with door 14 partially closed. FIG. 3C illustrates closure latch assembly 20 operating in an unlatched mode with door 14 permitted to move to its open position.

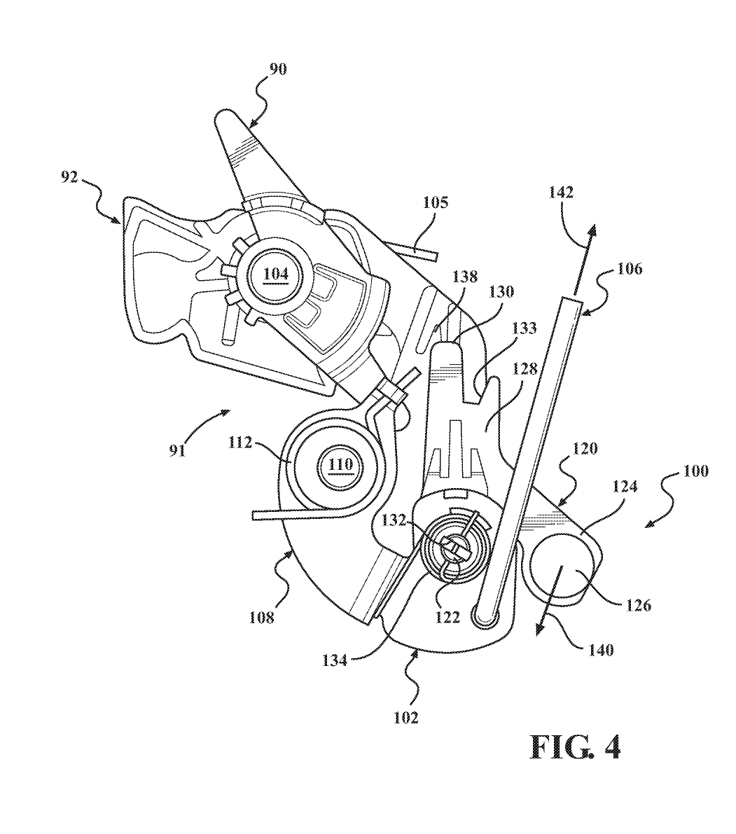

FIG. 2 illustrates pawl 46 to further include a pawl lug segment 76 which extends through a slot 78 formed in plate section 50 of latch housing 42. The locking mechanism associated with closure latch assembly 20 is operable to releasably retain pawl 46 in its ratchet holding position. The lock mechanism includes a lock lever 90 (FIG. 4) that is moveable (manually or via a power-operated lock actuator) between a first or “unlocked” position and a second or “locked” position with respect to pawl lug segment 76 of pawl 46. With lock lever 90 located in its unlocked position, a “latched/unlocked” mode is established for closure latch assembly 20 such that movement of pawl 46 to its ratchet releasing position is permitted. In contrast, location of lock lever 90 in its locked position establishes a “latched/locked” mode for closure latch assembly 20 and prevents movement of pawl 46 to its ratchet releasing position. Additionally, the latch release mechanism 91 associated with closure latch assembly 20 is operable to move pawl 46 from its ratchet holding position into its ratchet releasing position to establish the unlatched mode. The latch release mechanism 91 includes a latch release lever 92 (FIG. 4) that is moveable (manually or via a power-operated release actuator) between a first or “rest” position and a second or “actuated” position with respect to pawl lug segment 76 of pawl 46. With latch release lever 92 located in its rest position, the latched/unlocked mode is established with pawl 46 maintained in its ratchet holding position. In contrast, movement of latch release lever 92 to its actuated position causes pawl 46 to move to its ratchet releasing position which, in turn, permits ratchet 44 to rotate to its striker release position for establishing the unlatched mode.

The inside handle-actuated release mechanism and the outside handle-actuated release mechanism associated with closure latch assembly 20 are configured to directly or indirectly cause movement of pawl 46 from its ratchet holding position to its ratchet releasing position which, in turn, permits ratchet spring 74 to move ratchet 44 to its striker release position. FIG. 1 schematically illustrates a release cable 22 interconnecting inside door handle 16 to the inside release mechanism within closure latch assembly 20. Obviously, alternative arrangements for mechanically interconnecting inside door handle 16 to the inside latch release mechanism within closure latch assembly 20 are contemplated and available.

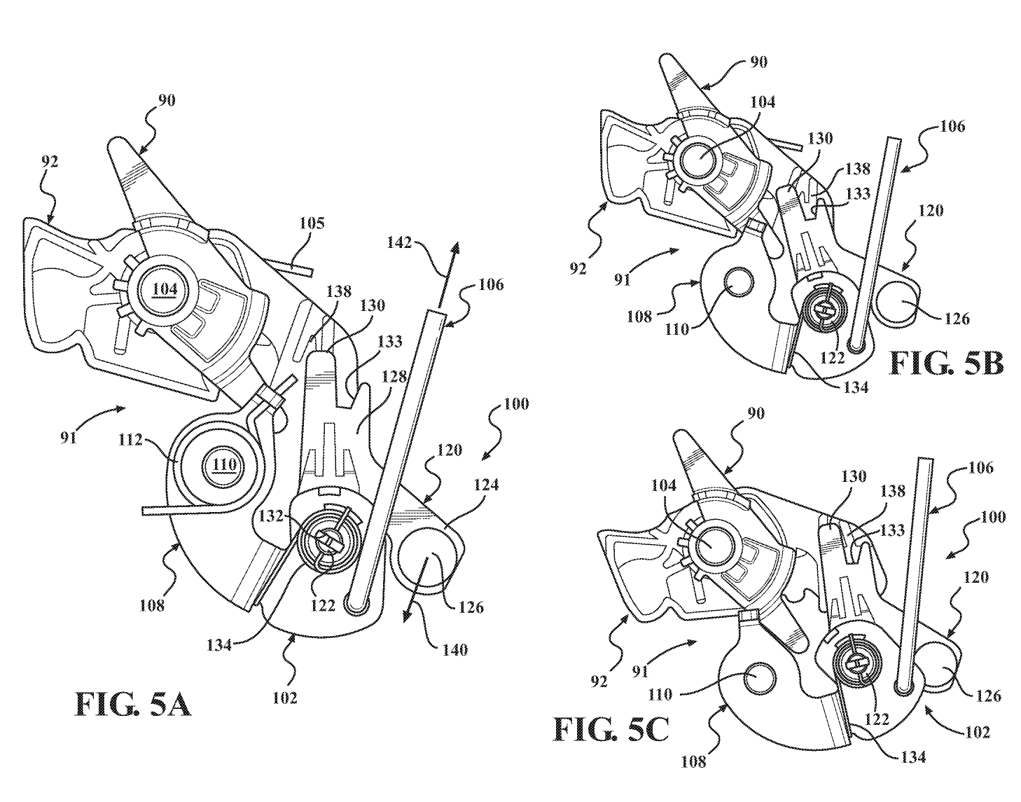

Referring particularly now to FIGS. 4 through 7, an inertia-activated bypass mechanism 100 is shown to be operably located between latch release lever 92 of the latch release mechanism 91 and an outside handle-actuated release mechanism 102 which, in turn, is mechanically connected to outside door handle 17. Latch release lever 92 and lock lever 90 are shown, in this non-limiting example, to be mounted to latch housing 42 (FIGS. 3A-3C) via a common pivot post 104. A release lever biasing spring 105 is partially shown and is configured to normally bias release lever 92 to its rest position. Outside handle-actuated release mechanism 102 is shown to include a connection device, also referred to as translational component, such as a release cable and/or rod 106, having one end connected to outside door handle 17 and another end coupled to a handle release lever, also referred to as release lever or outside release lever 108. Outside release lever 108 is pivotably mounted to latch housing 42 via an outside lever pivot post 110 for pivotal movement about a first arc of travel, and an outside release lever spring 112 provides a biasing force for normally biasing outside release lever 108 toward a first or “non-actuated” position (FIG. 5A). Bypass mechanism 100 includes an “unbalanced” link lever 120 having a first member or segment 122 pivotably mounted to outside release lever 108, a second segment 124 supporting an inertial mass 126 in spaced relation from first segment 122, and a third segment 128 formed with a latch member, referred to hereafter as drive lug 130, defining a forked drive notch 133. First segment 122 of lever link 120 defines an integral link lever pivot post 132 about which link lever 120 pivots, intermediate the second and third segments 124, 128, which extends through an aperture formed in outside release lever 108. The third segment 128 extends from the first segment 122 to the latch member 130, while the second segment 124 extends from or nearly from (meaning the second segment 124 can extend between the first and third segments 122, 128, but proximate the first segment 122) the first segment 122 to a free end, wherein the inertial mass 126 is fixed adjacent the free end of the second segment 124. In the non-limiting embodiment illustrated, the second and third segments 124, 128 extend in oblique relation with one another. A link lever spring 134 has a first spring end segment connected to link lever pivot post 132 and a second spring end segment acting on a flange section of outside release lever 108. The link lever 120 is “unbalanced” as a result of its center of mass being shifted from the pivot post 132 about which link lever 120 rotates via the inertial mass 126, and in the non-limiting embodiment illustrated in FIG. 4, the center of mass is shifted to the right of pivot post 132 with reference to a vertical axis passing through the center of pivot post 132, as viewed in FIG. 4. As such, link lever 120 resists rotation in a counterclockwise direction with release lever 108 in a high acceration event, as discussed further below.

Bypass mechanism 100 can be integrated into existing components of closure latch assembly 20 and is operable to prevent unintended release of latch mechanism 40 when closure latch assembly 20 is subjected to a high acceleration event and/or a collision event. Bypass mechanism 100 is unique in that it does not provide a “block release” function, but rather provides an inertia-activated “uncoupling” of the release chain of components, and particularly between outside release lever 108 and latch release lever 92. Such integration effectively minimizes complexity by eliminating the need for additional components. In operation, when latch mechanism 40 is subjected to high acceleration, above a predetermined threshold, from outside door handle 17, link lever 120 can be considered to be in an accelerating reference frame from a mechanical point of view. Specifically, an inertial force generated by inertial mass 126, as indicated by arrow 140 in FIG. 4, is presented at link lever's 120 center of mass. This inertial force is normally (i.e. under normal use and relatively low acceleration conditions) countered by the biasing applied to link lever 120 via link lever spring 134. As will be discussed, when the situation results in an inertial force greater than the biasing force exerted by link lever spring 134 (i.e. high acceleration event and/or a collision event), link lever 120 rotates relative to outside release lever 108 against the bias applied to link lever 120 via link lever spring 134 from a first or “coupled” position to a second or “uncoupled” position relative to latch release lever 92. The pivotal (rotational) movement of the link lever 120 against the bias imparted by link lever spring 134 is facilitated by the inertial mass 126 being offset relative to a resultant force vector acting on the link lever 120 from the acceleration applied to the translational component 106, as discussed in more detail hereafter.

FIGS. 5A through 5C illustrate a sequence of plan views for showing the use of outside door handle 17 to unlatch and open door 14 via actuation of outside release mechanism 102 during a normal (i.e. low acceleration) event. Prior to the outside door release operation, closure latch assembly 20 is latched and unlocked with ratchet 44 located in its primary striker capture position, pawl 46 located in its ratchet holding position, lock lever 90 located in its unlocked position, latch release lever 92 located in its rest position, outside release lever 108 located in its non-actuated position, and link lever 120 located in its coupled position relative to latch release lever 92. Specifically, with link lever 120 in its coupled position, link lever 120 is operable to couple drive lug (i.e. latch member) 130 to latch release lever 92, such that drive lug 130 of link lever 120 is mechanically engaged with latch release lever 92 to establish a “coupled” mode for bypass mechanism 100. More specifically, latch release lever 92 is formed with a drive lug 138 configured to selectively be retained within a forked drive notch 133 formed in drive lug 130 on link lever 120.

FIG. 5A illustrates initiation of a normal, low acceleration input force, indicated by arrow 142, being applied to release cable/rod 106 via actuation of outside door handle 17. This action results in pivotal movement of outside release lever 108 about the first arc of travel from its non-actuated position toward a second or “actuated” position (FIG. 5C). FIG. 5B illustrates a mid-release position whereat the movement of outside release lever 108 and link lever 120 causes drive lug 138 on latch release 92 to enter forked drive notch 133 on drive lug 130 which, in turn, begins to cause rotation of latch release lever 92 about pivot 104 from its rest position toward its actuated position while lock lever 90 remains in its coupled position. Finally, FIG. 5C illustrates a full-release position whereat the movement of outside release lever 108 and link lever 120 (due to movement of release cable/rod 106) has resulted in movement of latch release lever 92 into its actuated position. Accordingly, outside release lever 108 and link lever 120 move in normal operation in direct response to movement of the translational component 106. As noted, movement of latch release lever 92 to its actuated position results in movement (directly or indirectly) of pawl 46 from its ratchet holding position into its ratchet releasing position for allowing ratchet 44 to rotate to its striker release position so door 14 can be opened. Accordingly, in the aforementioned operation, latch release lever 92 is operatively coupled to pawl 46 such that movement of latch release lever 92 from its rest position into its actuated position results in corresponding movement of pawl 46 from its ratchet holding position into its ratchet releasing position via corresponding movement of link lever 120 with outside release lever 108. Note that during such routine low acceleration opening of door 14 (via intended, normal actuation of outside door handle 17 and outside handle-actuated release mechanism 102), the biasing force applied by link lever spring 134 on link lever 120 is sufficient to counter the low inertial force 140 applied by mass 126 to link lever 120 so as to maintain link lever 120 in its coupled position with bypass mechanism 100 operating in its coupled mode. Link lever 120 rotates about pivot 122 through an arc of travel the same as or substantially the same as (meaning that it can be slight different due to a minor deflection of link lever spring 134, but not substantially or significantly different) the first arc of travel of the outside release lever 108 to permit door opening under these low acceleration conditions.

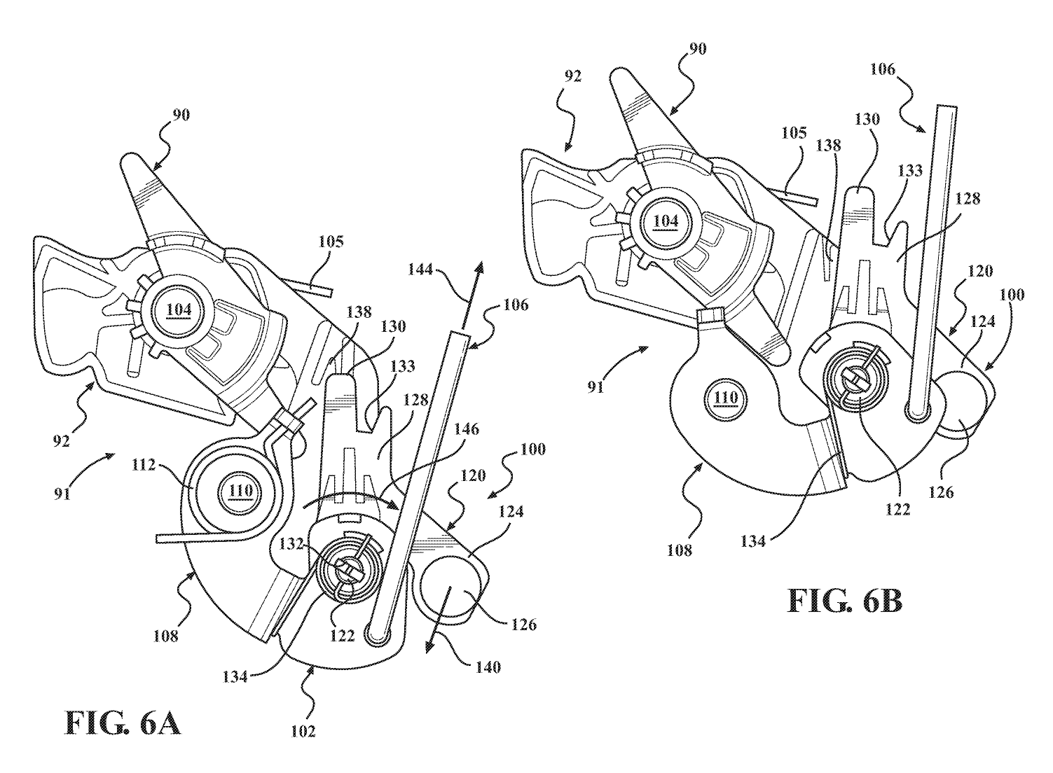

FIGS. 6A and 6B illustrate a sequence of views when a high acceleration input force, as indicated by arrow 144, is applied to bypass mechanism 100 via outside door handle 17 and/or via outside handle-actuated release mechanism 102. Note that FIG. 6A is generally identical to FIG. 5A to illustrate the initial location of the components prior to application of the high acceleration force 144. Specifically, closure latch assembly 20 is latched and unlocked with ratchet 44 in its primary striker capture position, pawl 46 in its ratchet holding position, lock lever 90 in its unlock position, latch release lever 92 in its rest position, and link lever 120 in its coupled position. However, rotational arrow 146 now illustrates the rotary movement of link lever 120 relative to outside release lever 108 about pivot 122 along a second arc of travel that is different from the first arc of travel when inertial force 140 exerted on unbalanced link lever 120 overcomes the biasing of link lever spring 134. This action results in drive lug (i.e. latch member) 130 of link lever 120 rotating to a position disengaged from drive lug 138 on latch release lever 92 to establish an “uncoupled” mode for bypass mechanism 100 in which link lever 120 is located in its uncoupled position relative to latch release lever 92. As such, subsequent movement of link lever 120 due to movement of outside release lever 108 toward its actuated position does not result in movement of latch release lever 92 from its rest position to its actuated position in response to the high acceleration input force 144 applied by translation component 106, whereby closure latch assembly 20 is maintained in its latched and unlocked mode and door 14 remains closed. Accordingly, outside release lever 108 and link lever 120 move in a high acceleration input condition in direct response to movement of the translational component 106. It is to be recognized that the second arc of travel can be different each time, depending on the magnitude of forces in action, which is made possible given the path traveled by the inertial mass 126 and the link lever 120 between the coupled position and the uncoupled position is not constrained by a predetermined path, such as slots or the like, but rather, the path along which link lever 120 traverses is unconstrained and “free-wheeling” about a compound path determined by the relative rotation of link lever 120 about pivots posts 110, 132. Following the removal of the high acceleration input force 144, outside release lever 108 and link lever 120 will automatically return to the positions shown in FIG. 6A under the bias of biasing members 112, 134, thereby automatically resetting link lever 120 in its coupled position with bypass mechanism 100 reset in its coupled mode.

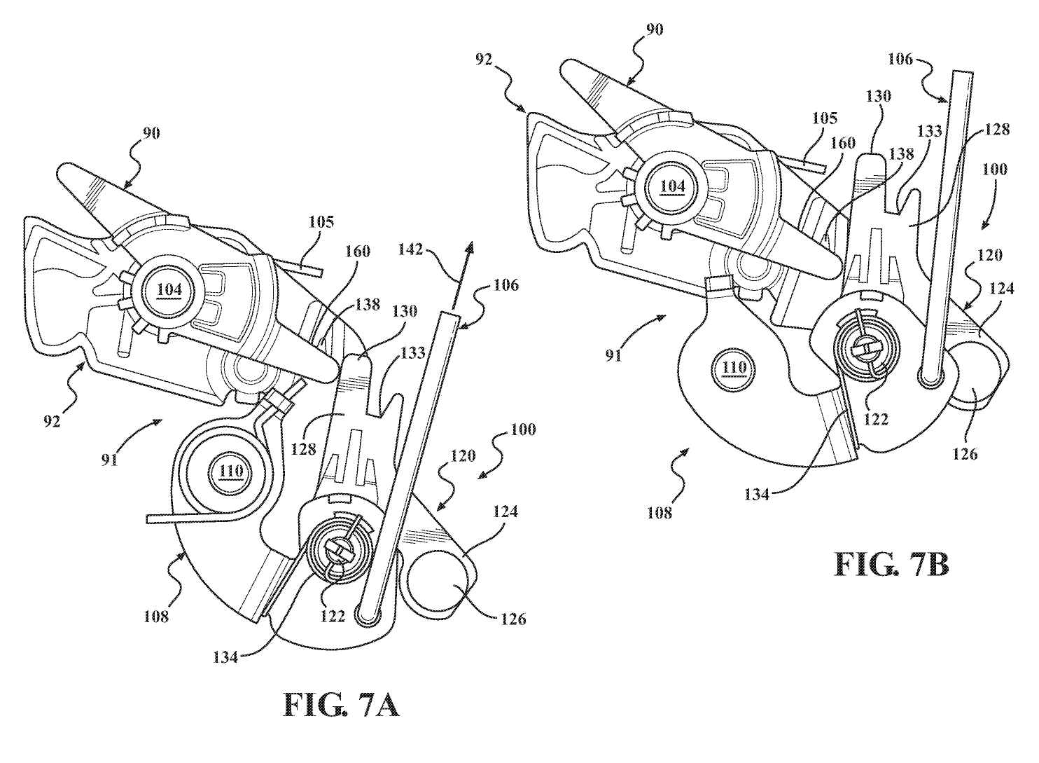

Referring now to FIGS. 7A and 7B, the components are shown with closure latch assembly 20 operating in its latched and locked mode such that ratchet 44 is located in its primary striker capture position, pawl 46 is located in its ratchet holding position, lock lever 90 is located in its locked position, latch release lever 92 is located in its rest position, and link lever 120 located in a third or “bypass” position. It will be noted that a bypass lug 160 formed on lock lever 90 mechanically engages drive lug 130 on link lever 120 when lock lever 90 is rotated about pivot point 104 into its locked position so as to physically hold and maintain link lever 120 in its bypass position. With link lever 120 held in its bypass position, drive lug 130 is again caused to rotate relative to outside release lever 108 against the bias of link lever spring 134 and remain disengaged from drive lug 138 on latch release lever 92. As such, when the normal low acceleration input force 142 is applied to cable/rod 106 via outside door handle 17, such action does not result in release of latch mechanism 40. The bypass and uncoupled positions associated with link lever 120 can be similar, but the size and configuration of lock lever 90 can dictate this arrangement.

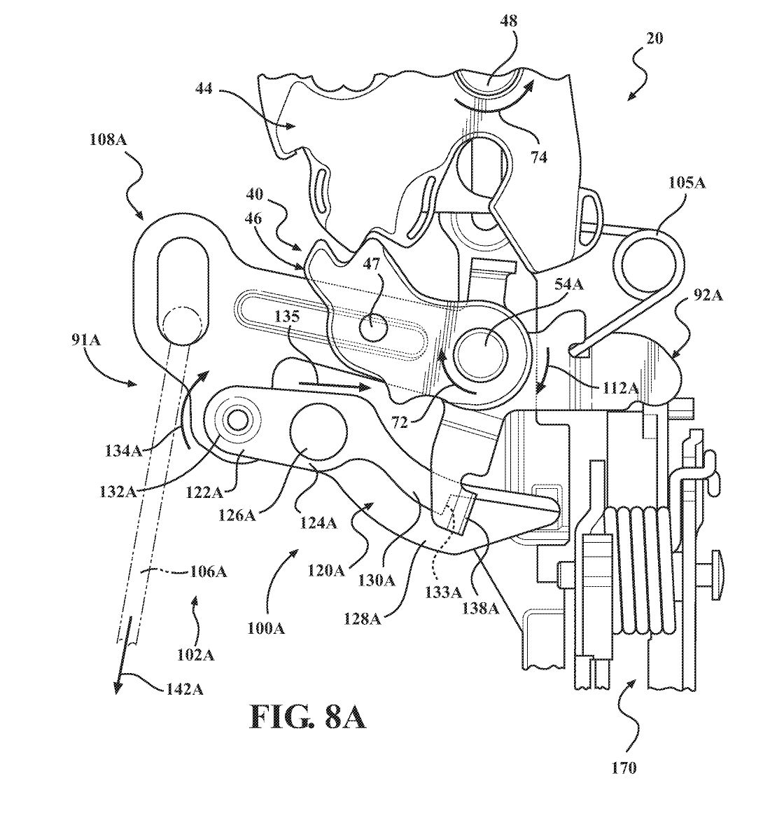

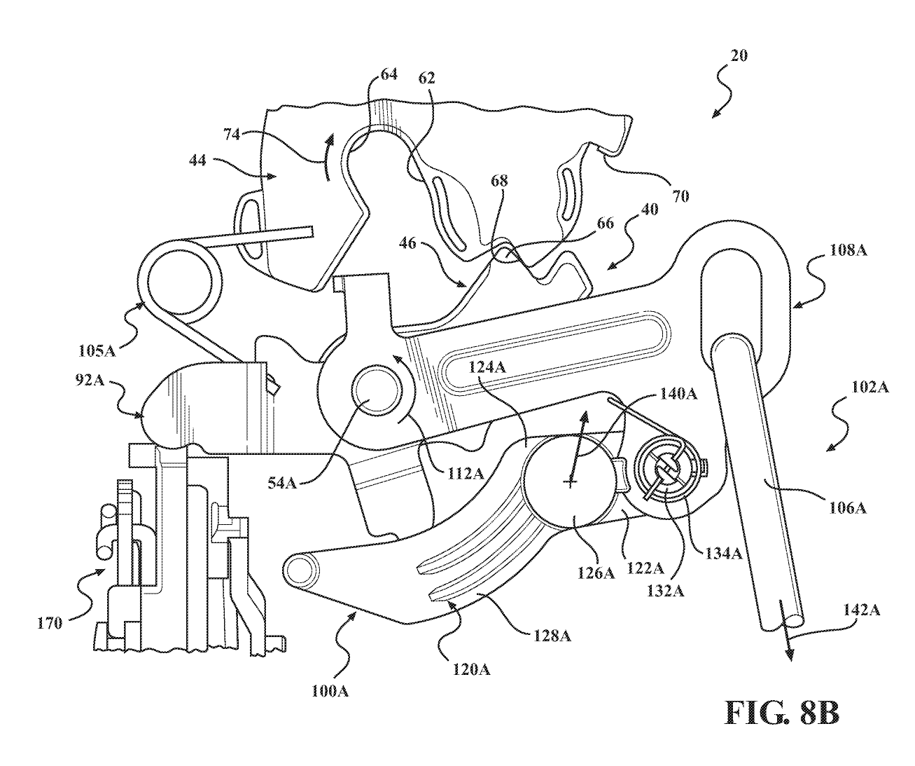

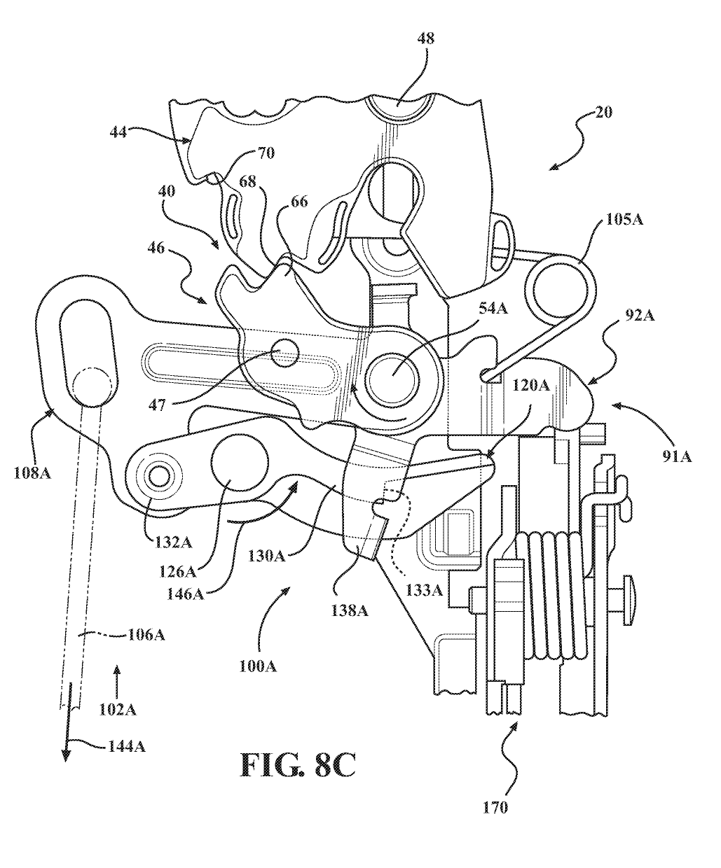

Referring now to FIGS. 8A-8C, an alternative embodiment of an inertia-activated bypass mechanism 100A is shown to be operatively located between a latch release lever 92A of the latch release mechanism 91A and a handle release lever, such as an outside release lever 108A associated with an outside handle-actuated release mechanism 102A, by way of example and without limitation, which, in turn, is mechanically connected to outside door handle 17. Latch mechanism 40 is again shown to include ratchet 44 and pawl 46 configured to function as previously described. Bypass mechanism 100A can be used in place of bypass mechanism 100 (FIGS. 4-7) for use in closure latch assembly 20 to provide the coupled and uncoupled modes established during normal, low acceleration actions associated with actuation of outside door handle 17 and inertia-generated high acceleration actions on outside door handle 17, respectively. Common reference numerals with an “A” suffix are used to identify components similar to those previously described. Generally speaking, bypass mechanism 100 of FIGS. 4-7 is configured to provide a “rotary” type interaction between link lever 120 and latch release lever 92 while bypass mechanism 100A of FIGS. 8A-8C is configured to provide a “push” type interaction between link lever 120A and latch release lever 92A, as better understood from the following description.

Latch release lever 92A is shown to be mounted to latch housing 42 via a common pivot post 54A shared with pawl 46 of latch mechanism 40. Release lever spring 105A is configured to normally bias latch release lever 92A toward its rest position (shown). Outside handle-actuated release mechanism 102A is shown in FIG. 8B to include a connection device 106A, such as a release cable or rod, having a first end connected to outside door handle 17 and a second end connected to outside release lever 108A. As seen, outside release lever 108A also shares common pivot post 54A with pawl 46 and latch release lever 92A. An outside release lever spring, schematically shown by arrow 112A, normally biases outside release lever 108A toward its non-actuated position. Bypass mechanism 100A includes an “unbalanced” link lever 120A having a first segment 122A pivotably mounted to outside release lever 108A, a second segment 124A supporting an inertial mass 126A, and a third segment 128A formed with a latch member, referred to also as drive lug 130A, defining a coupling notch 133A. First segment 122A of link lever 120A defines an integral link lever pivot post 132A extending through an aperture formed in outside release lever 108A. A link lever spring 134A acts between link lever pivot post 132A and outside release lever 108A.

As previously discussed, when latch mechanism 40 is exposed/subjected to high acceleration loading from outside door handle 17, link lever 120A acts as an accelerating reference frame from a mechanical point of view. Specifically, an inertial force generated by inertial mass 126A, as indicated by arrow 140A in FIG. 8B, is presented at link lever's 120A center of mass. This inertial force is normally (i.e. under normal use and relatively low acceleration conditions) counteracted by the biasing applied by link lever spring 134A to link lever 120A. However, when a situation occurs where an inertial force is exerted on link lever 120A that is greater than the biasing force of link lever spring 134A (i.e. high acceleration event and/or a collision event), link lever 120A rotates relative to outside release lever 108A against the bias imparted by link lever spring 134A from its coupled position (FIGS. 8A, 8B) into its uncoupled position (FIG. 8C) relative to latch release lever 92A. As will be detailed, bypass mechanism 100A operates in its coupled mode when link lever 120A is located in its coupled position and bypass mechanism 100A operates in its uncoupled mode when link lever 120A is located in its uncoupled position.

FIGS. 8A and 8B illustrate the components of latch mechanism 40, the latch release mechanism 91A, outside release mechanism 102A, and bypass mechanism 100A when closure latch assembly 20 is latched (and unlocked) prior to initiation of a normal, intended low acceleration outside door release operation. Specifically, ratchet 44 is located in its primary striker capture position, pawl 46 is located in its ratchet holding position, latch release lever 92A is located in its rest position, outside release lever 108A is located in its non-actuated position, and link lever 120A is located in its coupled position. A connection feature, such as a rivet 47, is provided for directly connecting pawl 46 for common movement with latch release lever 92A about pivot post 54A. In addition, with link lever 120A located in its coupled position, a latch lug 138A, formed on latch release lever 92A, is mechanically engaged with a coupling shoulder, projection, also referred to as coupling notch 133A, formed in drive lug 130A on link lever 120A. Initiation of a low acceleration input force, as indicated in FIG. 8B by arrow 142A, applied to connection device 106A via normal, intended actuation of outside door handle 17 causes pivotal movement of outside release lever 108A from its non-actuated position toward its actuated position about pivot post 54A. With link lever 120A in its coupled position, such pivotal movement of outside release lever 108A results in sliding movement of link lever 120A from a home position (FIG. 8A) toward a released position (not shown) in the direction of arrow 135. Such sliding movement of link lever 120A moves (i.e. “pushes”) latch release lever 92A to pivot about pivot post 54A from its rest position to its actuated position due to the mechanical “coupled” connection established between coupling notch 133A on link lever 120A and latch lug 138A on latch release lever 92A. As such, pawl 46 is moved by latch release lever 92A to its ratchet releasing position for allowing ratchet 44 to rotate into its striker release position. Note that during such a normal low acceleration opening of door 14 via actuation of outside door handle 17, the biasing force exerted by link lever spring 134A is sufficient to counteract inertial force 140A applied by mass 126A to link lever 120A, thereby maintaining link lever 120A in its coupled position as it slides between its home and released positions.

In contrast, FIG. 8C illustrates when a high acceleration force, as indicated by arrow 144A, is applied to bypass mechanism 100A via outside door handle 17 and/or via outside release mechanism 102A when closure latch assembly 20 is latched. Arrow 146A illustrates the rotary movement of link lever 120A about pivot post 132A relative to outside release lever 108A from its coupled position to its uncoupled position when inertial force 144A exerted on link lever 120A overcomes the biasing of link lever spring 134A. This action results in coupling notch 133A on drive lug 130A moving to a position disengaged from latch lug 138A on latch release lever 92A, thereby establishing the uncoupled mode for bypass mechanism 100A. As such, subsequent sliding movement of link lever 120A from its home position to its released position does not cause movement of latch release lever 92A from its rest position to its actuated position in response to the high acceleration force 144A, whereby closure latch assembly 20 is maintained in its latched mode with door 14 remaining latched and closed. Following removal of high acceleration input force 144A, outside release lever 108A and link lever 120A return to the positions shown in FIGS. 8A and 8B, thereby automatically resetting link lever 120A in its coupled position with bypass mechanism 100A reset to its coupled mode.

It should be understood that outside release lever 108A can be used as a combined inside/outside release member or, in the alternative, as an inside handle release lever as part of inside handle-actuated release mechanism without departing from the true scope of this invention so as to prevent high acceleration unintended release of latch mechanism 40 from inside the passenger compartment. Also, while FIGS. 8A-8C do not illustrate a lock lever, such as lock lever 90 of FIGS. 4-7, it is understood that such a lock lever could be again used and be operable in an unlocked position to permit movement of link lever 120A and in a locked position to hold link lever 120A in a bypass position. FIGS. 8A-8C also illustrate inside handle-actuated release mechanism 170 associated with closure latch assembly 20 and arranged to move latch release lever 92A between its rest and actuated positions in response to actuation of inside door handle 16.

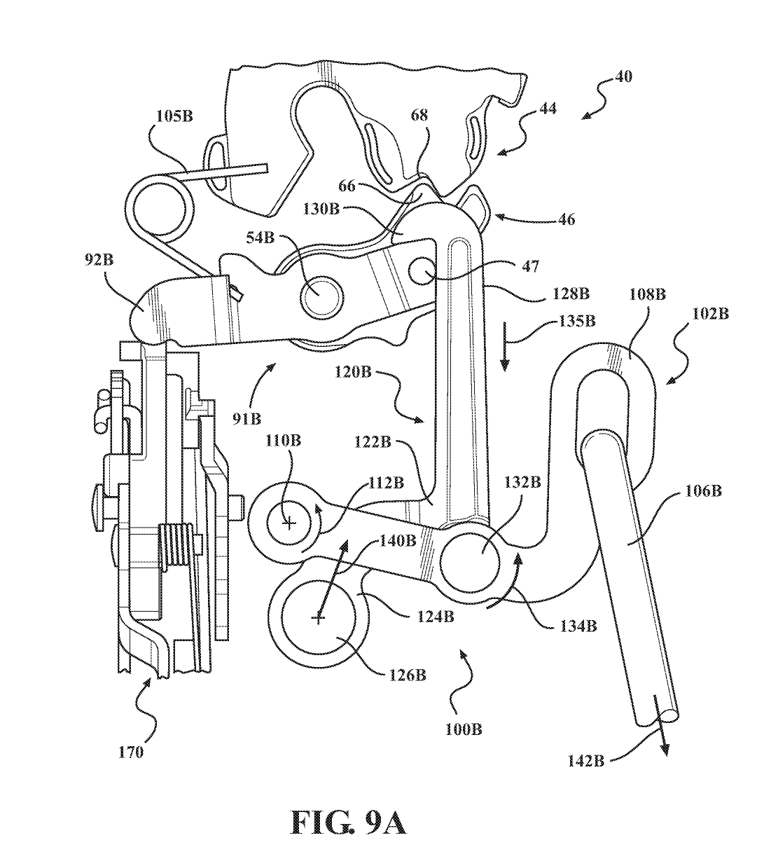

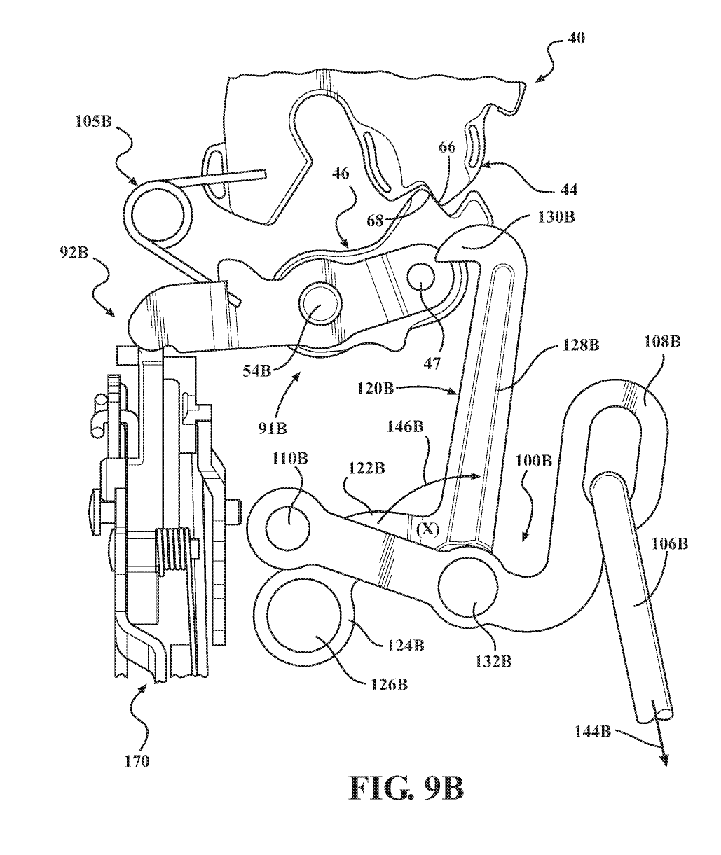

Referring now to FIGS. 9A and 9B, another alternative embodiment of an inertia-activated bypass mechanism 100B is shown to be operatively located between a latch release lever 92B of a latch release mechanism 91B and a handle release lever, such as an outside release lever 108B of an outside handle-actuated release mechanism 102B, by way of example and without limitation, which, in turn, is operatively connected to outside door handle 17. Latch mechanism 40 is again shown to include ratchet 44 and pawl 46 configured to function as previously described. Bypass mechanism 100B can be used in place of bypass mechanism 100 (FIGS. 4-7) and bypass mechanism 100A (FIGS. 8A-8C) in closure latch assembly 20 to provide the coupled and uncoupled modes that are respectively established during normal inertial actions (low acceleration actions associated with intentional actuation of outside door handle 17) and unintentional inertial actions (high acceleration actions associated with unintended impacts and/or forces applied to outside door handle 17 or closure latch assembly 20). Common reference numbers with a “B” suffix are used to identify components similar to those components previously described. Generally speaking, bypass mechanism 100B is configured to provide a “pull” type interaction between link lever 120B and latch release lever 92B which differs from the rotary interaction of bypass mechanism 100 and the push-type interaction of bypass mechanism 100A.

Latch release lever 92B is shown mounted to latch housing 42 via a common pivot post 54B shared with pawl 46. A drive pin or rivet 47 connects latch release lever 92B for common movement with pawl 46 such that movement of latch release leer 92B between its rest and pawl release positions results in movement of pawl 46 between its ratchet holding and ratchet releasing positions. Release lever spring 105B biases latch release lever 92B toward its rest position. Outside release lever 108B is shown pivotably mounted to latch housing 42 via pivot post 110B while outside release lever biasing spring 112B biases outside release lever 108B toward its non-actuated position (FIG. 9A). Bypass mechanism 100B includes unbalanced link lever 120B having a first segment 122B pivotably mounted to outside release lever 108B, a second segment 124B supporting an inertial mass 126B, and a third segment 128B formed with a latch member, also referred to as latch lug 130B, wherein the latch lug 130B is shown, by way of example and without limitation, as being hook-shaped at an end of the third segment 128B. First segment 122B is intermediated second and third segments 124B, 128B and defines an integral pivot post 132B extending through an aperture formed in outside release lever 108B. Link lever spring, illustrated schematically by arrow 134B, acts between link lever 120B and outside release lever 108B to normally bias link lever 120B toward its coupled position. An inertial force 140B exerted by mass 126B during normal, intended actuation is counteracted by spring 134B to locate and maintain link lever 120B in its coupled position. However, when a situation occurs where an inertial force greater than the biasing force of spring 134B is exerted on bypass mechanism 100B via outside door handle 17 or outside release lever 108B (i.e. resulting from a high acceleration event and/or a collision event), link lever 120B pivots from its coupled position (FIG. 9A) into its uncoupled position (FIG. 9B) relative to latch release lever 108B which causes latch lug 130B to move to a position out of alignment with drive pin 47. This action operates to shift bypass mechanism 100B from its coupled mode (FIG. 9A) into its uncoupled mode (FIG. 9B).

FIG. 9A illustrates the components of latch mechanism 40, the latch release mechanism 91B, outside handle-actuated release mechanism 102B, and bypass mechanism 100B when closure latch assembly 20 is latched (and unlocked if lock mechanism is integrated) prior to initiation of a low acceleration outside door release operation. Specifically, ratchet 44 is located in its striker capture position, pawl 46 is located in its ratchet holding position, latch release lever 92B is located in its rest position, outside release lever 108B is located in its non-actuated position, and link lever 120B is located in its coupled position. With link lever 120B located in its coupled position, latch lug 130B is aligned for engagement with drive pin 47. Initiation of a normal, low acceleration input force 142B applied to connection device 106B via outside handle 17 causes pivotal movement of outside release lever 108B toward its non-actuated position about pivot 110B. Such pivotal movement of outside release lever 108B results in a generally straight pulling action on link lever 120B which moves from a home position (FIG. 9A) toward a released position (not shown) in the direction indicated by arrow 135B.

Such sliding pull-type movement of link lever 120B causes latch lug 130B to remain in alignment with drive pin 47 so as to engage drive pin 47 and forcibly move latch release lever 92B from its rest position into its actuated position, thereby also moving pawl 46 from its ratchet holding position into its ratchet releasing position for releasing latch mechanism 40. Note that during such an intentional input force being applied to outside release lever 108B via actuation of outside door handle 17, the biasing force of spring 134B exerted on link lever 120B is sufficient to counteract the relatively low inertial force 140B applied thereto by mass 126B, thereby maintaining link lever 120B in its coupled position relative to drive pin 47 as it moves between its home and released positions.

In contrast, FIG. 9B illustrates when a high acceleration force 144B is applied to bypass mechanism 100B via outside handle 17 and/or via outside release mechanism 102B when closure latch assembly 20 is latched. Arrow 146B illustrates pivotal movement of link lever 120B about pivot post 132B from its coupled position to its uncoupled position relative to outside release lever 108B when the inertial force 140B exerted by mass 126B overcomes the biasing of spring 134B. As such, latch lug 130B is now located out of alignment with drive pin 47 such that pull-type movement of link lever 120B between its home and released positions does not result in release of latch mechanism 40 and closure latch assembly 20 is maintained in its latched mode. Bypass mechanism 100B is automatically reset to its coupled mode with link lever 120B in its coupled position following removal of the high acceleration inertial load being exerted thereon. Note that the center of mass “x” of link lever 120B is located above the pivot point of link lever 120B on outside release lever 108B.

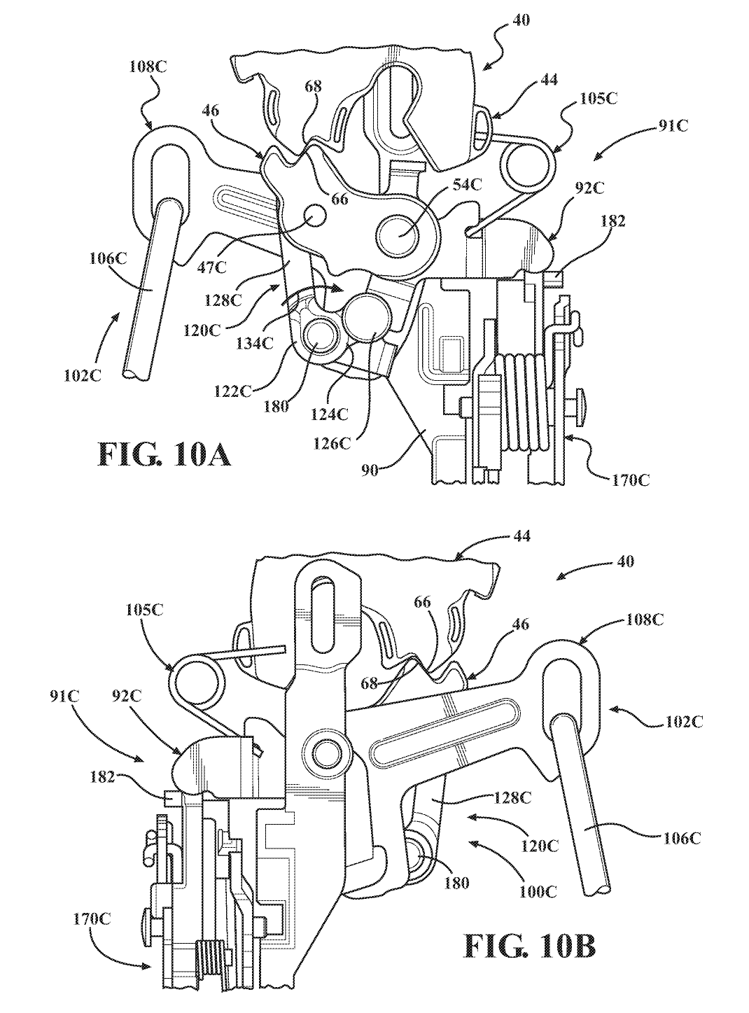

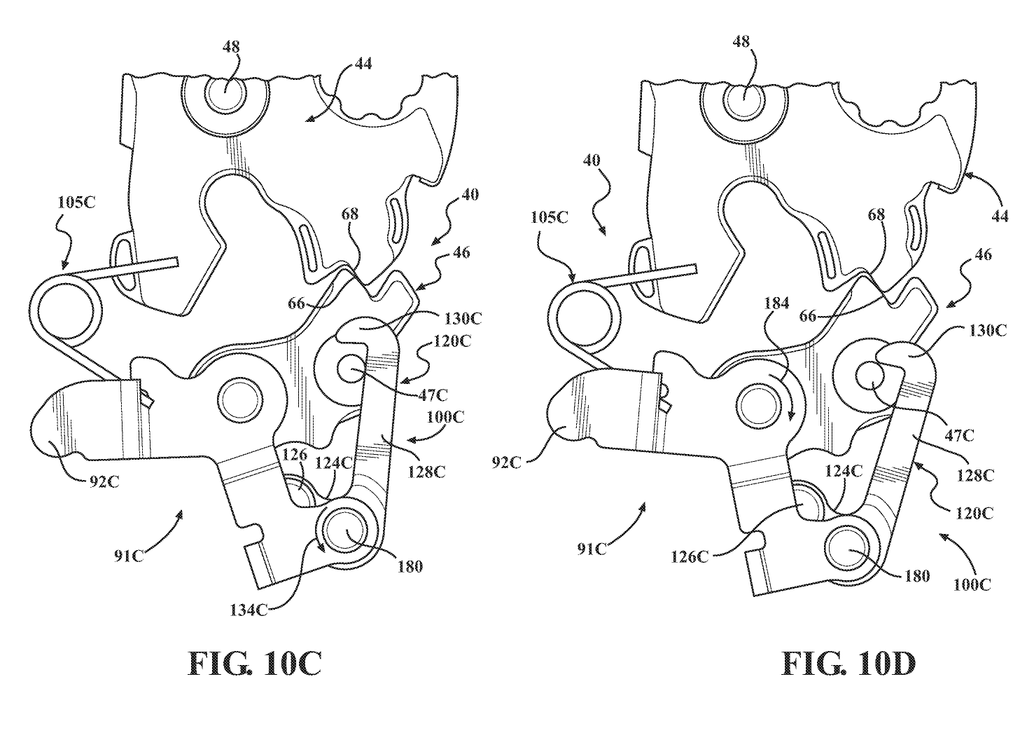

FIGS. 10A through 10D illustrate yet another alternative embodiment of an inertia-activated bypass mechanism 100C shown to be operatively located between latch release lever 92C of the latch release mechanism 91C and pawl 46 of latch mechanism 40. In this arrangement, link lever 120C is pivotably connected to latch release lever 92C about pivot 180 and includes a first segment 122C associated with pivot 180, a second segment 124C supporting mass 126C, and a third segment 128C having a latch member, also referred to as latch lug 130C, configured to selectively engage with drive pin 47C on pawl 46. In this arrangement, link lever 120C now functions to shift from its coupled position (FIGS. 10A-10C) to its uncoupled position (FIG. 10D) in the event a high acceleration event (i.e. high acceleration actions associated with unintended impacts and/or forces typically encountered in an accident) is exerted on either of outside release lever 108C or inside release mechanism 170C. FIG. 10C best illustrates engagement of latch lug 130C with drive pin 47C when link lever 120C is located in its coupled position. In this position, under normal acceleration (low acceleration actions associated with intentional actuation of outside/inside door handles), intended movement of latch release lever 92C via a handle release lever, such as outside release lever 108C or inside release lever 182, from its non-actuated position to its actuated position results in desired movement of pawl 46 from its ratchet holding position to its ratchet releasing position via engagement of latch lug 130C with drive pin 47C. In contrast, FIG. 10D illustrates that sudden, quick acceleration of latch release lever 92C, such as typically experience in a collision, causes inertial force 184 to overcome the biasing of link lever spring 134C and pivot link lever 120C to a position whereat latch lug 130C is displaced from drive pin 47C.

The bypass arrangement of the present disclosure is integrated into components of an otherwise conventional outside release mechanism such that a stand-alone inertia-activated safety system or device is not required, thereby providing the advantages of reduced complexity as well as reduced cost and packaging requirements. The present disclosure contemplates equivalent alternatives configured to include a translation component experiencing an acceleration above a predetermined acceleration threshold (PAT) which causes the inertial mass component to move (i.e. rotate, pivot, translate, etc.), whereupon a coupling component can be moved from a coupled interaction to an uncoupled interaction with a latch release component for providing a freewheeling inertia bypass device which improves upon conventional blocking devices. In other words, for accelerations of the translation component below the PAT, the coupling component (link lever) remains coupled with respect to the latch release component such that latch release function is maintained and intended, selective actuation of outside handle 17 provides for manual actuation of closure latch assembly 20 and thus the desired opening of door 14. On the contrary, for accelerations of the translation component exceeding the PAT, the coupling component (link lever) moves with respect to the latch release component to establish the uncoupled interaction therebetween whereby the latch release function is bypassed and the closure latch assembly 20 remains in its latched and unlocked mode for retaining closure panel (e.g. door 14) in its closed position. Functionally speaking, if the spring force exerted by the link lever spring (F_{S}) is greater than the input force applied to the handle (F_{H}) and an impact force (F_{I}) applied to closure latch assembly 20, then the link lever will remain located in its coupled position. In contrast, if the spring force (F_{S}) is less than the handle force (F_{H}) or the impact force (F_{I}), then the link lever will rotate about its inertia mass since the spring force F_{S} cannot overcome the resistive inertial force.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A closure latch assembly, comprising;
a latch mechanism including a ratchet moveable between a striker capture position and a striker release position, a pawl moveable between a ratchet holding position for holding the ratchet in its striker capture position and a ratchet releasing position for permitting the ratchet to move to its striker release position, a ratchet biasing member operable to bias the ratchet toward its striker release position, and a pawl biasing member operable to bias the pawl toward its ratchet holding position;
a latch release mechanism having a latch release lever moveable between a rest position and an actuated position, and a latch release lever spring operable to bias the latch release lever toward its rest position, the latch release lever being operatively coupled to the pawl such that movement of the latch release lever from its rest position into is actuated position results in corresponding movement of the pawl from its ratchet holding position into its ratchet releasing position;
a handle-actuated release mechanism having a translational component coupled to a handle and a handle release lever coupled to the translational component; and
an inertia-activated bypass mechanism including a link lever having a first segment pivotably coupled to the handle release lever and a link lever spring acting between the handle release lever and the link lever, the link lever having a second segment with a latch member and a third segment with an inertial mass,
wherein the inertial mass causes the link lever to move from a coupled position to an uncoupled position in response to an acceleration above a predetermined acceleration threshold applied to the translational component, wherein the link lever is operable in its coupled position to couple the latch member to the latch release lever and is operable in its uncoupled position to uncouple the latch member from the latch release lever.

2. The closure latch assembly of claim 1, wherein the link lever is operable in its coupled position to cause the latch member to engage and move the latch release lever from its rest position into its actuated position in response to actuation of the handle-actuated release mechanism when the acceleration applied to the translational component is below the predetermined acceleration threshold so as to establish a coupled mode for the inertia-activated bypass mechanism, and wherein the link lever is operable in its uncoupled position to locate the latch member to be disengaged from the latch release lever such that the latch release lever is maintained in its rest position in response to actuation of the handle-actuated release mechanism when the acceleration exceeds the predetermined acceleration threshold so as to establish an uncoupled mode for the bypass mechanism.

3. The closure latch assembly of claim 2, wherein the link lever pivots along a first arc of travel when the acceleration is below the predetermined acceleration threshold and pivots along a second arc of travel when the acceleration is above the predetermined acceleration threshold, wherein the first arc of travel is different from the second arc of travel.

4. The closure latch assembly of claim 3, wherein the handle release lever pivots along the first arc of travel when the acceleration is below the predetermined acceleration threshold.

5. The closure latch assembly of claim 1, wherein the path traveled by the inertial mass and the link lever between the coupled position and the uncoupled position is not constrained by a predetermined path.

6. The closure latch assembly of claim 1, wherein the latch member of the link lever moves away from engagement with the latch release lever when moving from the coupled position toward the uncoupled position.

7. The closure latch assembly of claim 1, further including a lock mechanism having a lock lever moveable between an unlocked position and a locked position, wherein the pawl is permitted to move to its ratchet release position when the lock lever is in its unlocked position and the pawl is held in its ratchet holding position when the lock lever is in its locked position, and wherein the lock lever holds the link lever in its uncoupled position when the lock lever is in its locked position.

8. The closure latch assembly of claim 1, wherein the inertial mass is offset relative to a resultant force vector acting on the link lever from the acceleration applied to the translational component.

9. The closure latch assembly of claim 1, wherein the first segment is intermediate the second and third segments, and wherein the third segment extends from the first segment to a free end, the inertial mass being adjacent the free end.

10. The closure latch assembly of claim 9, wherein the second and third segments extend in oblique relation with one another.

11. The closure latch assembly of claim 9, wherein the second segment extends from the first segment to the latch member.

12. The closure latch assembly of claim 1, wherein the latch member has a forked drive notch configured for receipt of a drive lug on the latch release lever when the link lever is in its coupled position.

13. The closure latch assembly of claim 12, wherein the forked drive notch is spaced from the drive lug on the latch release lever when the link lever is in its uncoupled position.

14. The closure latch assembly of claim 1, wherein the latch member has a shoulder configured to push on a drive lug on the latch release lever when the link lever is in its coupled position.

15. The closure latch assembly of claim 14, wherein the shoulder is configured to be spaced from the drive lug when the link lever is in its uncoupled position.

16. The closure latch assembly of claim 1, wherein the latch member is hook-shaped to pull on a drive lug on the latch release lever when the link lever is in its coupled position.

17. The closure latch assembly of claim 16, wherein the hook-shaped latch member is spaced from the drive lug on the latch release lever when the link lever is in its uncoupled position.

18. A closure latch assembly, comprising;
a latch mechanism including a ratchet moveable between a striker capture position and a striker release position, a pawl moveable between a ratchet holding position for holding the ratchet in its striker capture position and a ratchet releasing position for permitting the ratchet to move to its striker release position, a ratchet biasing member operable to bias the ratchet toward its striker release position, and a pawl biasing member operable to bias the pawl toward its ratchet holding position;
a latch release mechanism having a latch release lever moveable between a rest position and an actuated position, and a latch release lever spring operable to bias the latch release lever toward its rest position, the latch release lever being operatively coupled to the pawl such that movement of the latch release lever from its rest position into is actuated position results in corresponding movement of the pawl from its ratchet holding position into its ratchet releasing position;
a handle-actuated release mechanism having a translational component coupled to a handle and a handle release lever coupled to the translational component; and
an inertia-activated bypass mechanism including a link lever having a first segment pivotably coupled to the handle release lever and a link lever spring acting between the handle release lever and the link lever, the link lever having a second segment with a latch member and a third segment with an inertial mass,
wherein the inertial mass causes the link lever to pivot along a first arc of travel with the handle release lever to a coupled position to couple the latch member to the latch release lever when the acceleration is below the predetermined acceleration threshold, and to pivot along a second arc of travel away from the latch release lever to an uncoupled position with the latch release lever when the acceleration is above the predetermined acceleration threshold, wherein the first arc of travel is different from the second arc of travel.

19. The closure latch assembly of claim 18, wherein the path traveled by the inertial mass and the link lever between the coupled position and the uncoupled position is not constrained by a predetermined path.

20. The closure latch assembly of claim 19, wherein the latch member of the link lever moves away from engagement with the latch release lever when moving from the coupled position toward the uncoupled position.
